(19) United States
(12) Patent Application Publication
(10) Pub. No.: US 2015/0135976 A1
(43) Pub. Date: May 21, 2015

(54) Sani Smasher

(71) Applicant: Sylvia Lynne Maheux, Boyds, MD (US)

(72) Inventor: Sylvia Lynne Maheux, Boyds, MD (US)

(21) Appl. No.: 14/060,717

(22) Filed: Nov. 18, 2013

(51) Int. Cl. B65F 1/14

(52) U.S. Cl. CPC B65F 1/1405
USPC 100/214

(57) ABSTRACT

The Sani-Smasher allows for the smashing and compacting of your household garbage without your hands ever touching soiled garbage. The Sani-Smasher is new because it will save consumers money by not having to press their garbage down using paper towels or risk tearing the existing bag by using the top of bag to smash garbage down in the bin. The Sani-Smasher is always readily available to use because it “sits” in its' own unique, air-holed compartment, within the container.

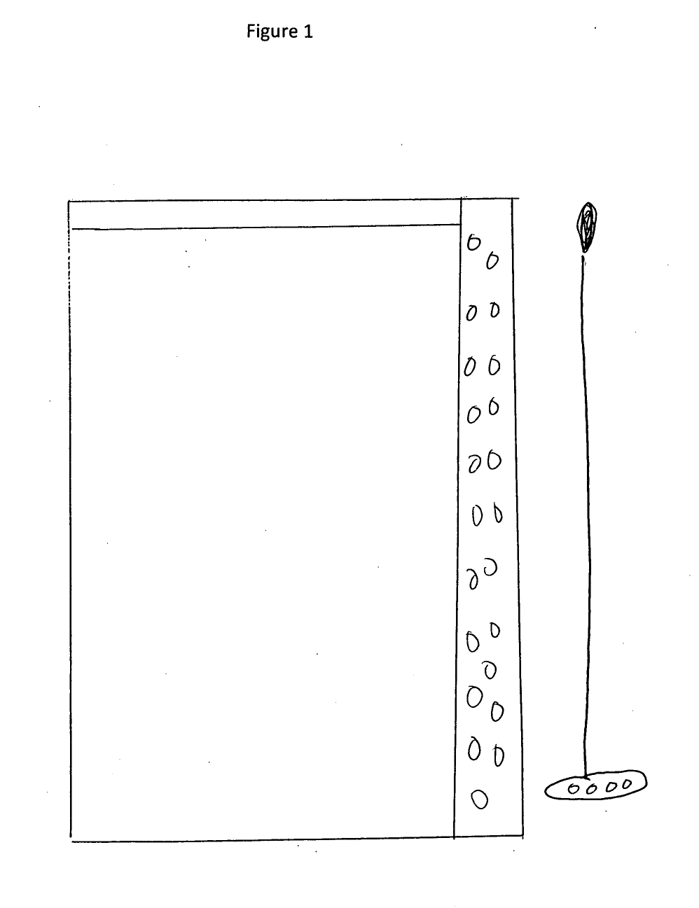

### CROSS-REFERENCE TO RELATED APPLICANTS

Previously discovered United States patents which appear to be similar to my invention:

U.S. Pat. No. 4,158,995

Inventor(s): Kaplan et. al.

Issue Date: Jun. 26, 1979

U.S. Pat. No. 5,862,748

Inventor(s): Witter

Issue Date: Jan. 26, 1999

U.S. Pat. No. 3,565,351

Inventor(s): Ross

Issue Date: Feb. 23, 1971

U.S. Pat. No. 5,997.060

Inventor(s): Sperduto

Issue Date: Dec. 7, 1999

U.S. Pat. No. 5,090,756

Inventor(s): Pfisterer

Issue Date: Feb. 25, 1992

U.S. Patent Des. 256,770

Inventor(s): Broyles

Issue Date: Sep. 9, 1980

### BACKGROUND OF INVESTIGATION

The endeavor which my Invention pertains to is to allow the user to “Smash” garbage down in bin by using the “smasher”. The smasher is readily available in its own separate side-compartment of the garbage bin. The side bin has air holes to allow the smasher to air-out after each use (smash).

This is a Utility item. The process is to smash garbage without soiling the user's hands. The function is to smash the garbage in a sanitary manner (Sani-Smasher).

The product produced is compacted garbage which allows the bin to hold more garbage and prevent waste and spillage out of the garbage pin. This saves the user money using less garbage bags and less soap to wash hands after handling garbage.

### BRIEF SUMMARY OF INVENTION

My Sani-Smasher is a home tall kitchen bin with a slender, vertical, divided compartment. This compartment has small air holes. The actual smasher sits within this compartment as part of the overall garbage bin. When garbage bin is full, the smasher compartment may also be opened and the smasher is removed in order to smash garbage down. Smasher can then be sprayed with an sanitizing spray or simply be place back in bin.

This allows more garbage to be placed in the bin and the user's hands never touch the soiled garbage.

The bin is a tall kitchen trash can (stainless steel, hard plastic, various colors). Main compartment is solid and is the largest portion, which will contain the rubbish. The vertical, divided side compartment is the remaining portion of the trash can and is just large enough to house the smasher. It has air holes for the smasher.

The smasher is a hard plastic or a stainless steel rod, with smasher at the end, coated with a resin. (various colors to match trash can).

Previous type of hand held inventions were used in either large-scale commercial settings and were very large sizes, comparable to an actual shovel.

1. The Sani-smasher allows the trash can to hold more rubbish.

2. The Sani-smasher keeps hands free from touching the actual rubbish.

3. The Sani-smasher is fun to use and is safe for anyone to use.
